(19) United States
(12) Patent Application Publication
(10) Pub. No.: US 2015/0298617 A1
(43) Pub. Date: Oct. 22, 2015

(54) Magnetic Holding System For Keeping A Hat In A Car

(71) Applicant: Steve Welch, Las Cruces, NM (US)

(72) Inventor: Steve Welch, Las Cruces, NM (US)

(21) Appl. No.: 14/255,798

(22) Filed: Apr. 17, 2014

(51) Int. Cl. B60R 7/10

(52) U.S. Cl. CPC B60R 7/10

(57) ABSTRACT

A magnetic holding system for safe keeping hats or caps in a vehicle when not in use comprises at least one piece of rare earth magnet which is pinned or removably attached to a headliner of a vehicle, and a piece of metal which is sewn or removably attached to a hat or cap. In use, the metal piece attached or pinned on the hat or cap can be removably held to the rare earth magnet on the headliner through a magnetic attraction force thereby the hat or cap is removably held to the headliner of the vehicle. The metal piece may be removably attached to the hat or cap using fabric hook-and-loop fasteners adhered to the back of the metal piece. The rare earth magnet may be removably attached to the headliner using fabric hook-and-loop fasteners adhered on the back of the rare earth magnet.

### BACKGROUND OF THE INVENTION

1. Field of the Invention

This invention relates generally to hat holders, and more particularly to a hat holding system using magnetic force used in a vehicle.

2. Description of Related Art

Hat wearers often require a place to store their hats while driving in a motor vehicle like a car or a truck.

Utilizing a ring shaped holder for storing a brimmed hat or cap against a surface such as the headliner (the fabric covering the inside of the roof of an automobile) in a vehicle is known in the prior art. More specifically, by way of example, U.S. Pat. No. 6,059,246 to Robbins discloses a hat holder comprising a length of stiff material that retains its shape when formed by hand. The length of stiff material is formed first into a closed loop before pinching. The crown of a hat is received into the opening between the pinches. The opening is adjustable. The holder may then be fixed at one end to an overhead surface to store the hat.

U.S. Pat. No. 5,092,472 to Jones discloses a hat holder having a crown ring and at least one adjustable strap for receiving a hat of the type having a crown and a brim for securing the hat to a surface. In a preferred embodiment, a pair of straps are connected to the surface by means of a first pair of Velcro pads connected to the ends of the straps and a second pair of Velcro pads adhesively connected to the surface whereby the hat may be conveniently placed or removed from the holder by simply separating one or both such straps at the Velcro pads from the surface.

A magnetic holding system using rare earth magnets for keeping a hat or cap from getting crushed on a car seat or falling on the floor when driving in a car and not wearing the hat or cap itself is new in the art.

### SUMMARY OF THE INVENTION

In an exemplary embodiment of the present invention, there is disclosed a magnetic holding system for keeping a hat or cap from getting crushed on an automobile seat or falling on the floor when driving in a car and not wearing the hat itself. The system comprises a magnet that is pinned or attached to the headliner (i.e. the fabric covering the inside of the roof of an automobile) of a car or an automobile seat, and a piece of metal that is sewn, pinned or attached to one's hat or cap itself. When the hat or cap is not worn in the car, the hat with the metal piece can be held on the magnet on the headliner through a magnetic force.

The magnets used in the system are called rare earth magnets which create a stronger hold than traditional magnets. The metal piece that attaches to one's hat or cap can be a piece of magnet or steel. This magnet system could be any shape or size and could be attached to the headliner in several ways, pined, glued, using fabric hook-and-loop fasteners such as Velcro® and etc.

The unique feature of the invention is using a rare earth magnet to hold a hat or cap to the headliner in a vehicle for safe keeping so the hat or cap won't get crushed by sitting on car seat or floor or get faded in the sun by sitting on the dashboard of the vehicle. The metal piece attached to the hat or cap could be steel or another rare earth magnet. The metal piece can be attached to the hat or cap in a variety of ways, pinned, glued, sewn, using fabric hook-and-loop such as Velcro®, and etc.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of an rare earth magnet soldered with a pin which is a part of the hat holding system according to an embodiment of the present invention.

FIG. 2 is a rear view of an rare earth magnet soldered with a pin which is a part of the hat holding system according to an embodiment of the present invention.

FIG. 3 shows several magnets with pins inserted into the head liners of a car.

FIG. 4 shows a metal piece having pins to insert into a hat.

FIG. 5 shows a hat which is attached to the head liner of a vehicle using the hat holding system of the present invention.

FIG. 6 shows two magnets with pins inserted into the back of a car seat.

FIG. 7 shows a hat is attached to the back of a seat of a vehicle using the hat holding system of the present invention.

FIG. 8 shows a rear view of an rare earth magnet glued with a fabric hook and loop fastener which is a part of the hat holding system according to an embodiment of the present invention.

FIG. 9 shows a rear view of a metal piece glued with a fabric hook and loop fastener and a front view of the metal piece attached to a hat using the fabric hook-and-loop fastener.

### DESCRIPTION OF THE PREFERRED EMBODIMENT

A hat holding system for keeping a hat from getting crushed on a car seat or falling on the floor when driving in a car and not wearing the hat itself. The system comprises a magnet that has means to attach to the headliner of a car or a seat, and a piece of metal that has means to attach to one's hat or cap itself. The magnets used in the system are called rare earth magnets which create a stronger hold than traditional magnets. This rare earth magnet could be any shape or size and could be attached to the headliner in several ways, pinned, glued, using two-way tapes, using fabric hook and loop fasteners such as Velcro® hook and loop and etc. The metal piece could be any shape or size and could be attached to the hat or cap in several ways, pinned, glued, using two-way tapes, using fabric hook and loop fasteners such as Velcro® hook and loop and etc. The piece of metal that attaches to one's hat or cap can be a magnet or a piece of steel.

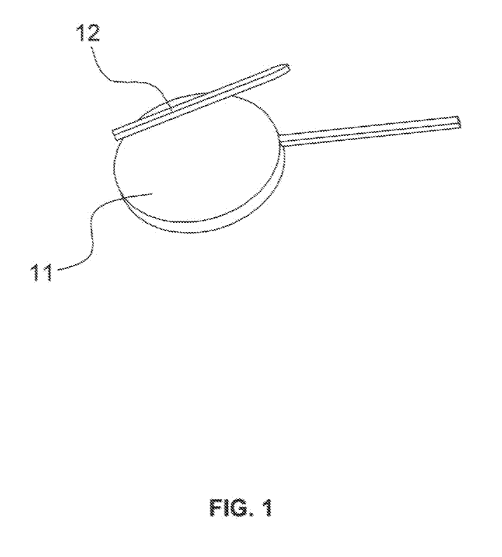

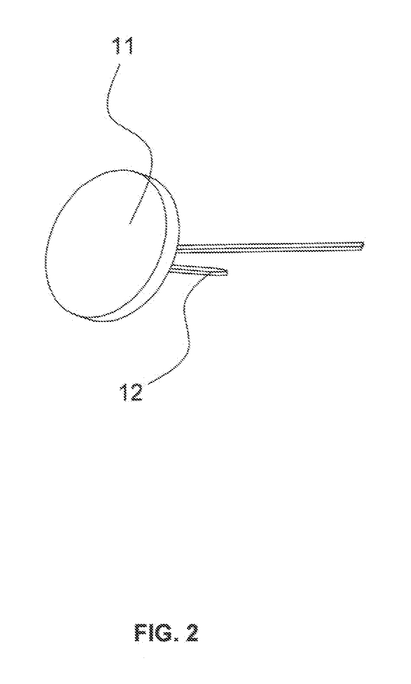

Referring to FIGS. 1-2, there is disclosed an rare earth magnet 11 soldered with a pin 12 which is a part of the hat holding system 10 according to an embodiment of the present invention.

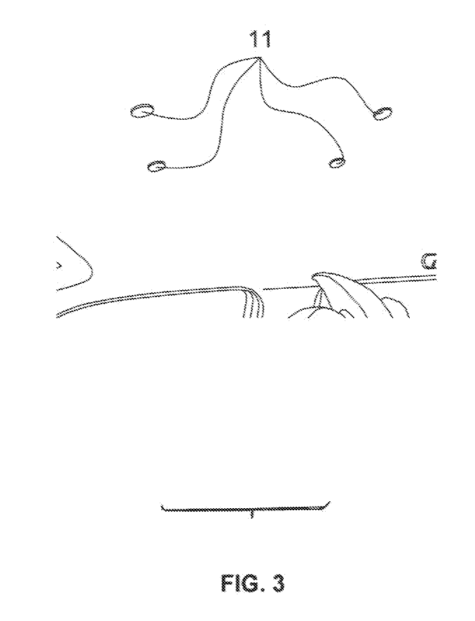

FIG. 3 shows several magnets 11 with pins inserted into the head liners 20 of a car.

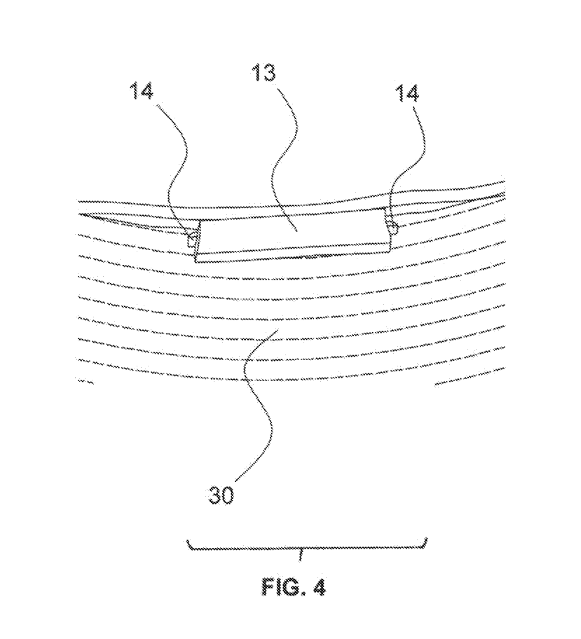

FIG. 4 shows a piece of metal 13 which is a part of the hat holding system 10 that is attached to a hat 30. In this embodiment, the metal piece 13 has pins 14 on two ends to insert into the hat 30.

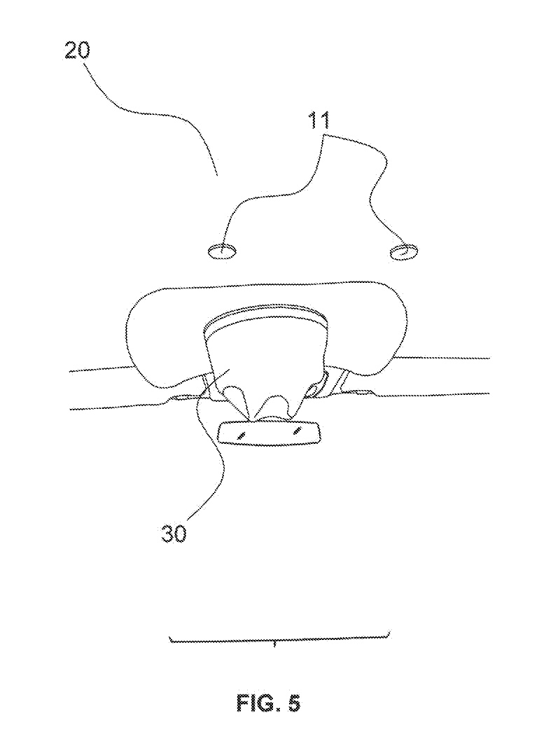

FIG. 5 shows a hat 30 which is held onto the headliner 20 of a vehicle using the hat holding system 10 (not observable in this figure) of the present invention via magnetic attraction force.

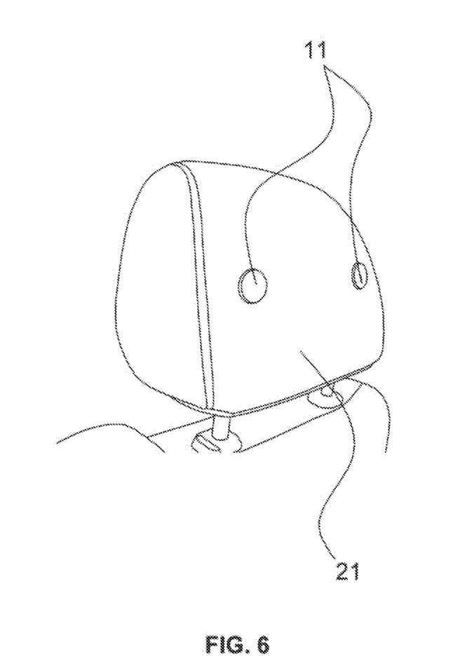

FIG. 6 shows two magnets 11 with pins (not observable in this figure) inserted into the back of a car seat 21.

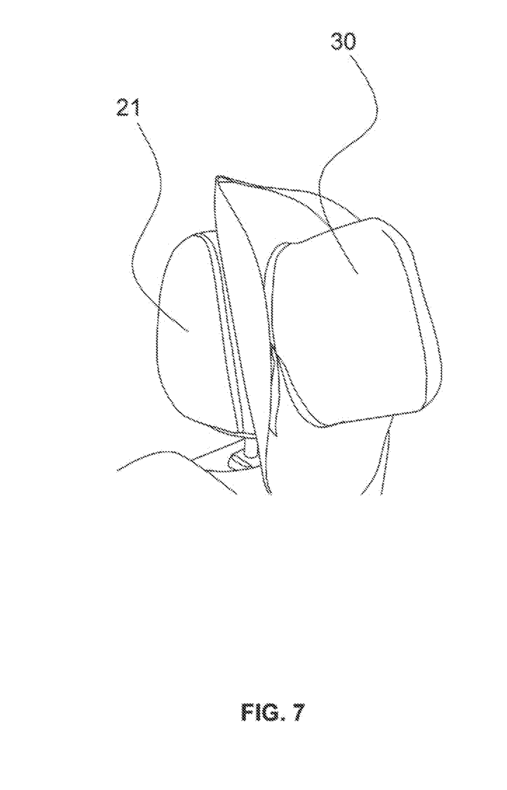

FIG. 7 shows a hat 30 is attached to the back of an automobile seat 21 of a vehicle using the hat holding system 10 of the present invention via magnetic attraction force.

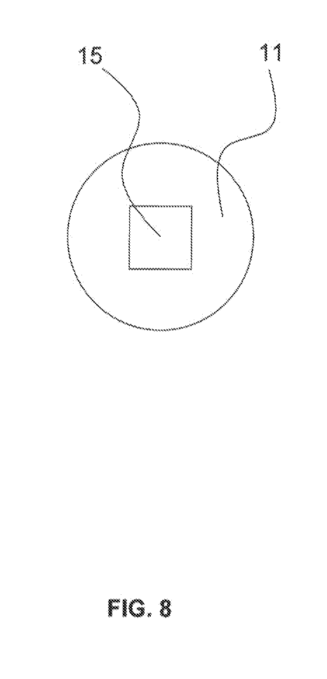

FIG. 8 shows a rear view of an rare earth magnet glued with a fabric hook-and-loop fastener 15 such as Velcro® hook-and-loop. The rare earth magnet 11 with the fabric fastener could be attached to the headliner 20 made of fabric in the vehicle or the back of an automobile seat 21 made of fabric.

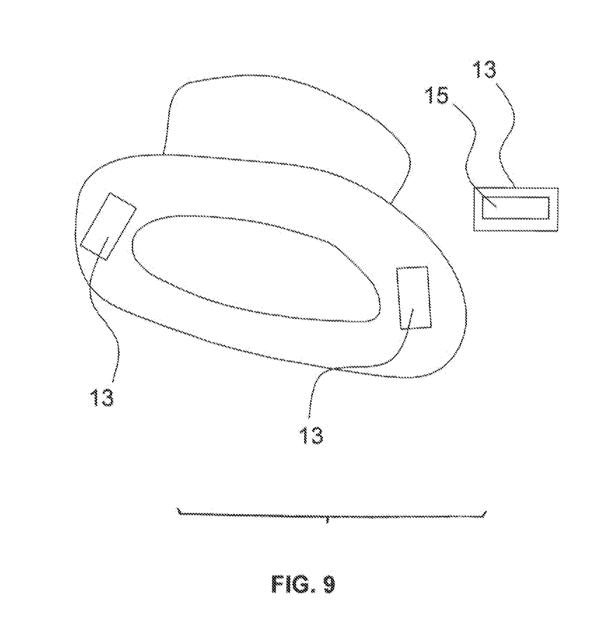

FIG. 9 shows a rear view of a metal piece glued with a fabric hook-and-loop fastener 15 such as Velcro® hook-and-loop, and a front view of such a metal piece 11 attached to a hat using the fabric hook-and-loop fastener.

The hat 30 with the metal piece 13 is then attached to the rare earth magnet 11 which is already attached or pinned or glued on the headliner 20; the hat 30 is then held to the headliner 20 by the magnetic force. If the hat or cap is not made of fabric, a piece of fabric hook-and-loop fastener could be glued to the hat or cap.

Alternatively, the metal piece 13 can be sewn into the hat or cap 30 or directly glued to the hat or cap.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

1. A magnetic holding system for keeping a hat from getting crushed in a vehicle comprising:
at least a piece of earth magnet having a first attachment means to attach to a headliner or an automobile seat of a vehicle;
at least a piece of metal meant to attach to a hat or cap via a second attachment means;
wherein when the piece of metal is attached to the hat or cap and the piece of earth magnet is attached to the headliner or automobile seat of the vehicle, the hat or cap can be removably held to the headliner or automobile seat through a magnetic attraction force.

2. The system of claim 1, wherein the first attachment means includes at least one pin which is soldered to the piece of earth magnet.

3. The system of claim 1, wherein the first attachment means includes at least one fabric hook-and-loop fastener which is adhered to the piece of earth magnet.

4. The system of claim 1, wherein the second attachment means includes glue which adhere the piece of metal directly to the hat or cap.

5. The system of claim 1, wherein the second attachment means includes at least one fabric hook-and-loop fastener which is adhered to the piece of metal such that the piece of metal can be removably attached to the hat or cap using the fabric hook-and-loop fastener.

6. The system of claim 1, wherein the second attachment means includes at least one pin which can be removably inserted into the hat or cap.

7. The system of claim 1, wherein the second attachment means is stitching whereby the piece of metal is sewn into the hat or cap.

8. The system of claim 1, wherein the piece of metal is a magnet.

9. The system of claim 1, wherein the piece of metal is a piece of steel.

10. The system of claim 1, wherein the first and second attachments are two-way tapes.

11. A magnetic holding system for keeping a hat from getting crushed in a vehicle comprising:
at least a piece of earth magnet having at least a pin to insert into a headliner or an automobile seat of a vehicle;
at least a piece of metal having at least a pin to insert into a hat or cap;
wherein the piece of metal is pinned to the hat or cap, the piece of earth magnet is pinned to the headliner or automobile seat of the vehicle, and the hat or cap is removably held to the headliner or automobile seat through a magnetic attraction force.

12. The system of claim 11, wherein the piece of metal is a magnet.

13. The system of claim 11, wherein the piece of metal is a piece of steel.

14. A magnetic holding system for keeping a hat from getting crushed in a vehicle comprising:
at least a piece of earth magnet having at least a fabric hook-and-loop fastener to attach to a headliner or an automobile seat of a vehicle;
at least a piece of metal having at least a fabric hook-and-loop fastener to attach to a hat or cap;
wherein the piece of metal is removably attached to the hat or cap, the piece of earth magnet is removably attached to the headliner or automobile seat of the vehicle, and the hat or cap is removably held to the headliner or automobile seat through a magnetic attraction force.

15. The system of claim 14, wherein the piece of metal is a magnet.

16. The system of claim 14, wherein the piece of metal is a piece of steel.
